(19) United States
(12) Patent Application Publication
(10) Pub. No.: US 2025/0313233 A1
(43) Pub. Date: Oct. 9, 2025

(54) VEHICLE TRAVEL PATH DETERMINATION

(71) Applicant: Motional AD LLC, Boston, MA (US)

(72) Inventors: Niamul Quader, Singapore (SG); Sucipta Alexander, Singapore (SG); Michael Oden, Pittsburgh, PA (US)

(21) Appl. No.: 18/286,948

(22) PCT Filed: Apr. 14, 2023
(86) PCT No.: PCT/US2023/018676

§ 371 Date: Oct. 13, 2023

Related U.S. Application Data
(60) Provisional application No. 63/435,905, filed on Dec. 29, 2022.

(51) Int. Cl. B60W 60/00; B60W 30/18

(52) U.S. Cl. CPC B60W 60/0011; B60W 30/18159; B60W 60/0015; B60W 60/0021; B60W 2530/201; B60W 2552/53; B60W 2554/60; B60W 2556/40

(57) ABSTRACT

Provided are methods for travel path determination, which can include obtaining mapping data characterizing an environment, the mapping data indicating mapping data indicating boundaries of a first road lane in the environment; identifying a portion of the first road lane as a narrowed road lane, the narrowed road lane having a reduced width in at least a portion of the narrowed road lane compared to a width of the first road lane; evaluating a plurality of candidate travel paths in a search space that includes the narrowed road lane and excludes at least a portion of the first road lane that is not included in the narrowed road lane; and determining a particular travel path for a vehicle through the narrowed road lane based on the evaluation of the plurality of candidate travel paths. The plurality of candidate travel paths include the particular travel path.

### CROSS-REFERENCE TO RELATED APPLICATIONS

This application claims the benefit of the priority date of U.S. Provisional Patent Application No. 63/435,905, filed Dec. 29, 2022.

### BACKGROUND

Autonomous or semi-autonomous vehicles navigate through environments based on sensor and other data. Mapping data of the environments can be used to determine travel paths through road lanes and intersections.

### BRIEF DESCRIPTION OF THE FIGURES

FIG. 1 is an example environment in which a fleet management system and a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram of a travel path;

FIG. 6 is a diagram of an example of a process of determining a travel path;

FIG. 7 is a diagram of road lanes;

FIGS. 8A-8E are diagrams of road lanes;

FIG. 9 is a diagram of nodes in a road lane;

FIG. 10 is a diagram of an example of a process of determining a travel path;

FIGS. 11A-11C are diagrams of shrinking hypercubes defining nodes;

FIG. 12 is a diagram of an example of a process of determining a connector path;

FIG. 13 is a diagram of a connector path.

### DETAILED DESCRIPTION

In the following description, numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature.

Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement techniques to determine travel paths for vehicles, such as autonomous or semi-autonomous vehicles. In some embodiments, the search space for the travel path can be limited to a narrowed road lane based on curbs, parking, and other features. In some embodiments, a shrinking hypercube optimization process is used to determine nodes of the travel path.

By virtue of the implementation of the systems, methods, and computer program products described herein, travel paths can be determined more quickly, e.g., in real-time or near-real-time, by reducing the search space for the travel paths. The determined travel paths can be better in one or more aspects than travel paths defined by other processes, e.g., can be safer by avoiding obstacles in the vicinity of a road lane. In some embodiments, travel path determination can be accelerated by use of a shrinking hypercube optimization process for determination of nodes of the travel path. In some embodiments, connector paths between travel paths can be determined quickly by one or more of (i) search space reduction in an area between the travel paths (e.g., an intersection) or (ii) a node-based connector path determination process. Accordingly, travel paths can be determined accurately, rapidly, and efficiently by computing systems that are remote from vehicles, and/or by computing systems on board the vehicles themselves.

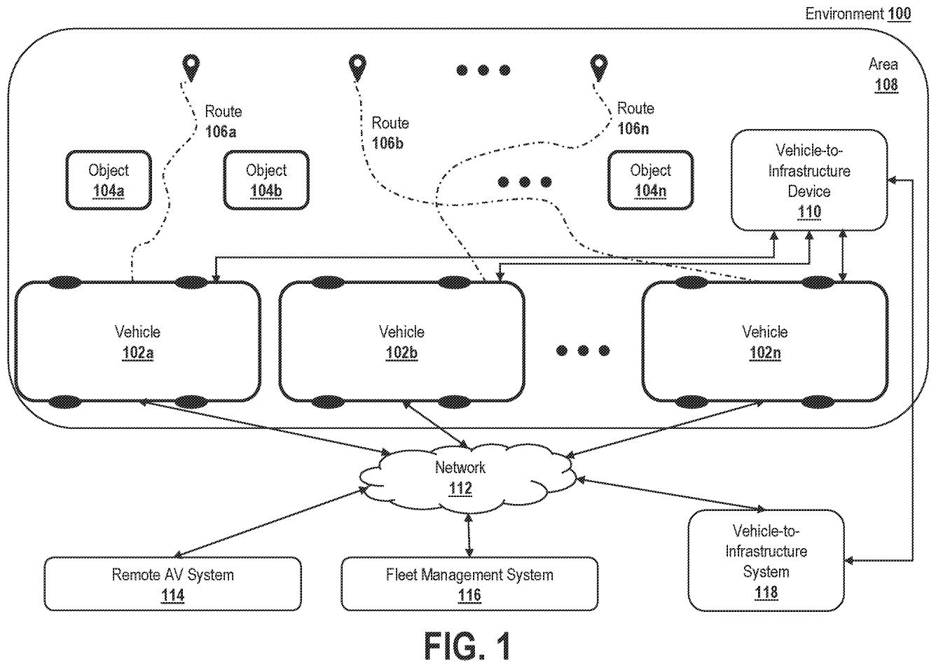

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

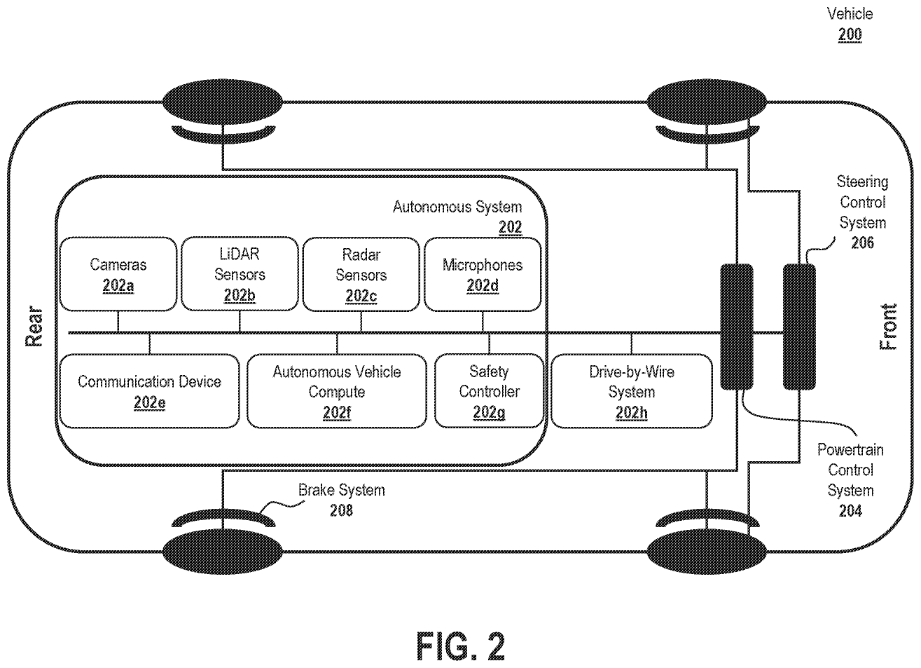

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region. When the routes 106 are associated with spatial trajectories within and/or between road lanes or other roadways that vehicles 102 are caused to follow, the routes 106 can be referred to as “travel paths.”

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like). The fleet management system 116 can provide route data and/or travel path data to the vehicles 102 to cause the vehicles 102 to navigate based on the route data and/or travel path data.

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 with autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

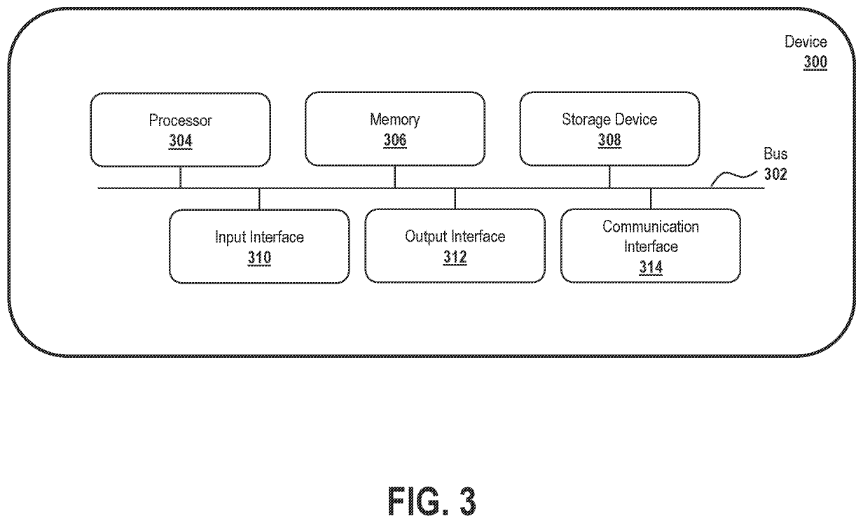

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of remote AV system 114, at least one device of fleet management system 116, at least one device of vehicle-to-infrastructure system 118, and/or one or more devices of network 112 (e.g., one or more devices of a system of network 112). In some embodiments, one or more devices of vehicles 102 (e.g., one or more devices of a system of vehicles 102), one or more devices of remote AV system 114, one or more devices of fleet management system 116, one or more devices of vehicle-to-infrastructure system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

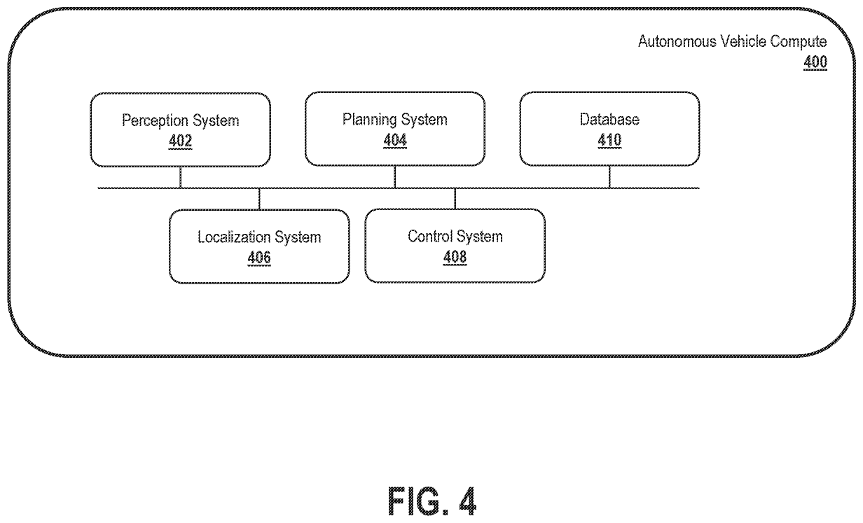

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments, perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

In some embodiments, a vehicle (such as vehicles 102 and/or vehicle 200) navigates based on a travel path through an environment. A travel path includes one or more points and/or trajectories in and/or through one or more drivable areas, the travel path usable for one or more purposes. In some implementations, a travel path is used to guide vehicle navigation, e.g., navigation of an autonomous or semi-autonomous vehicle. In some implementations, a travel path is used to predict movement of a nearby vehicle. For example, based on sensor data indicative of the nearby vehicle, the nearby vehicle can be assigned to a predicted travel path that the nearby vehicle is likely to follow, and an autonomous or semi-autonomous vehicle can determine its own navigation based on the predicted travel path.

Determination of and/or use of travel paths is not limited to the direct context of vehicle navigation. For example, in some implementations, a set of travel paths for an environment can be used to predict traffic behavior of the environment. As another example, one or more travel paths can be used to model vehicle movement for autonomous vehicle simulation (e.g., training of at least one machine learning model) and/or for safety studies.

In some implementations, a travel path is a baseline travel path that defines a reference path for vehicle navigation through one or more road lanes. The baseline travel path can define an ideal travel path along which a vehicle navigates in the absence of objects and/or conditions that dictate deviations from the baseline travel path. In some implementations, multiple baseline travel paths can be defined for a given portion of an environment. For example, different baseline travel paths can correspond to different vehicles (e.g., different vehicle sizes), different temporal conditions (e.g., rush hour compared to other times), different weather conditions (e.g., raining compared to clear weather), and/or different routes to be travelled (e.g., a first baseline travel path in a road lane for a vehicle proceeding down the road lane and continuing straight at an intersection, and a second baseline travel path through the road lane for a vehicle proceeding down the road lane and turning left at the intersection).

For example, in some embodiments, the database 410 or another element of the autonomous vehicle compute 400 of an autonomous vehicle stores data indicative of baseline travel paths through road lanes in an environment. The baseline travel paths can be received at the autonomous vehicle compute 400 from a remote source (e.g., fleet management system 116, which can determine the baseline travel paths in some embodiments according to this disclosure) and/or the baseline travel paths can be determined by the autonomous vehicle compute 400 (e.g., by planning system 404 or another element of the autonomous vehicle compute 400).

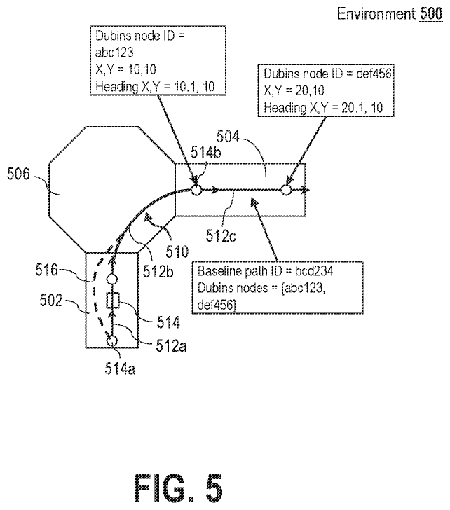

A baseline travel path can include portions through one or more road lanes, intersections, and/or other drivable areas. Referring to FIG. 5, an environment 500 includes a first road lane 502, a second road lane 504, and an intersection 506 between the first road lane 502 and the second road lane 504. A baseline travel path 510 is defined through the environment 500, the baseline travel path 510 including a first portion 512a through the first road lane 502, a second portion 512 through the second road lane 504, and a connector portion 512c between the first portion 512a and the second portion 512b, e.g., through the intersection 506. Each portion 512a, 512b, 512c can be referred to individually as a travel path.

In some embodiments a travel path, such as the baseline travel path 510, is defined by a plurality of nodes (e.g., nodes 514a, 514b), such as Dubins nodes. Each Dubins node is associated with a location and a heading. For example, the location can be expressed in absolute coordinates (e.g., GPS coordinates or longitude and latitude coordinates) and/or local coordinates (e.g., an x-value and a y-value in reference to a reference position), as shown in FIG. 5. The heading can be expressed in absolute coordinates (e.g., an angle with respect to a North direction) and/or local coordinates (e.g., an angle with respect to a reference position). A set of Dubins nodes defines a travel path between the Dubins nodes such that a vehicle navigating on the travel path passes through each Dubins node and, at each Dubins node, has the heading of the Dubins node. A pair of Dubins nodes defines the travel path between the Dubins nodes. Given a first Dubins node having a heading, travel is performed a small discrete distance from the first Dubins node (e.g., several cm) along the heading. The heading is then recalculated by interpolation, such that the heading value slowly changes from the first Dubins node's heading to the second Dubins node's heading as the vehicle iteratively travels along the path. Travel paths can additionally or alternatively be defined based on another type of node, such as a set of nodes where the vehicle travels on linear paths between each pair of adjacent nodes.

Navigating in the environment 500, an autonomous or semi-autonomous vehicle may by-default travel along the baseline travel path 510, which may approximately track, for example, a center of a road lane. For example, in some embodiments, the planning system 404 generates trajectories that follow the baseline travel path 510, the trajectories being provided to the control system 408 to cause corresponding movement of the vehicle. However, data received by the planning system 404 may cause a navigated trajectory to deviate from the baseline travel path 510. Deviation(s) from the baseline travel path 510 can be based on obstructing object(s), changes in road condition, changes in traffic regulation (e.g., road signage or traffic signals), and/or other reasons. For example, one or more sensors (e.g., one or more sensors of the autonomous system 202) can detect an object 514 in or in proximity to a roadway that would obstruct the vehicle navigating along the baseline travel path 510. Accordingly, in some embodiments, the planning system 404 determines a trajectory along an altered travel path, such as an altered travel path 516 that avoids the object 514. In some embodiments, the altered travel path 516 is determined so as to return to the baseline travel path 510, representing a temporary deviation from the baseline travel path 510.

Some embodiments according to this disclosure relate to a process of determining travel paths, such as baseline travel paths and other types of travel paths, using a reduced search space based on a narrowed road lane. The term “road lane,” as used herein, refers not only to basic lanes of roads, streets, highways, and other roadways, but also to other bounded areas in which a vehicle may navigate, such as driveways, traffic circles, paths in garages, and off-road paths.

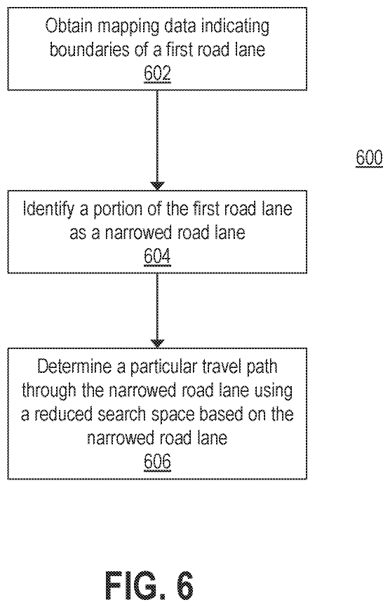

Referring now to FIG. 6, process 600 can be performed by a system of an autonomous or semi-autonomous vehicle (e.g., by autonomous vehicle compute 400), by one or more systems remote to a vehicle (e.g., fleet management system 116 and/or vehicle-to-infrastructure system 118), or a combination thereof.

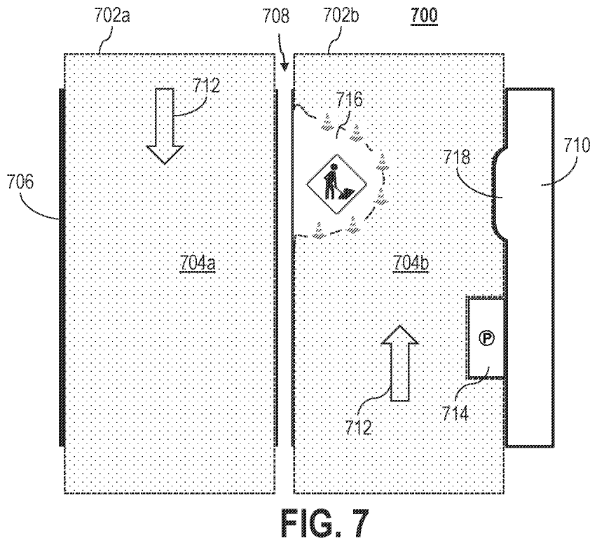

The process 600 includes obtaining mapping data indicating boundaries of a first road lane (602). As shown in FIG. 7, the mapping data can spatially describe an environment 700 and indicate boundaries 702a, 702b (referred to generally as boundaries 702) of one or more road lanes 704a, 704b (referred to generally as road lanes 704). In various embodiments, the boundaries 702 can track one or more types of environmental feature. In the example of FIG. 7, the boundaries 702 track a railing 706, road paint 708, a curb 710, a parking spot 714, a construction area 716, and a curb protrusion 718, each of which is an example of an environmental feature. In some embodiments, the boundaries 702 indicated by the mapping data can be defined more expansively, e.g., the boundaries 702 can track the railing 706, the road paint 708, and the curb 710 to indicate broader road lanes that may include one or more of the parking spot 714, the construction area 716, or the curb protrusion 718. In some implementations, the boundary 702 accounts for some environmental features, such as permanent or semi-permanent features such as the parking spot 714 and the curb protrusion 718, but does not account for other environmental features, such as temporary features such as the construction area 716 (e.g., such that the initially-provided road lanes include construction areas). Various configurations of the boundaries 702 to include/exclude various types of environmental feature are within the scope of this disclosure.

The mapping data can be obtained from one or more sources. In some embodiments, the mapping data is at least partially stored locally in a computing system performing the process 600, e.g., in a storage device 308 of a device 300 of a vehicle 102 or a fleet management system 116. In some embodiments, the mapping data is at least partially obtained from a remote source, e.g., by downloading the mapping data over network 112. In some embodiments, the environmental features are indicated in the mapping data.

The environmental features can be permanent or semi-permanent (e.g., the railing 706 and the curb 710) and/or can be transient (e.g., construction area 716). Although some environmental features, such as the curb protrusion 718 and the railing 706, can be obstacles with which a vehicle may collide, some embodiments include environmental feature(s) that are not obstacles, such as crosswalk indicators, curb cuts, signage, and any other feature in the environment 700. Further examples of environmental features include vehicles (whether moving or parked), pedestrians and other road users, and flora such as trees. Any one or more of these and/or other types of environmental feature can be used as a basis for narrowing a road lane to obtain a narrowed road lane, as described in further detail below.

In some embodiments, each road lane 704 is associated in the mapping data with a direction 712 indicating a direction of travel in the road lane 704. The mapping data can have any format suitable for analysis to determine travel paths, such as data indicating lane properties (e.g., path offset and/or parking offset).

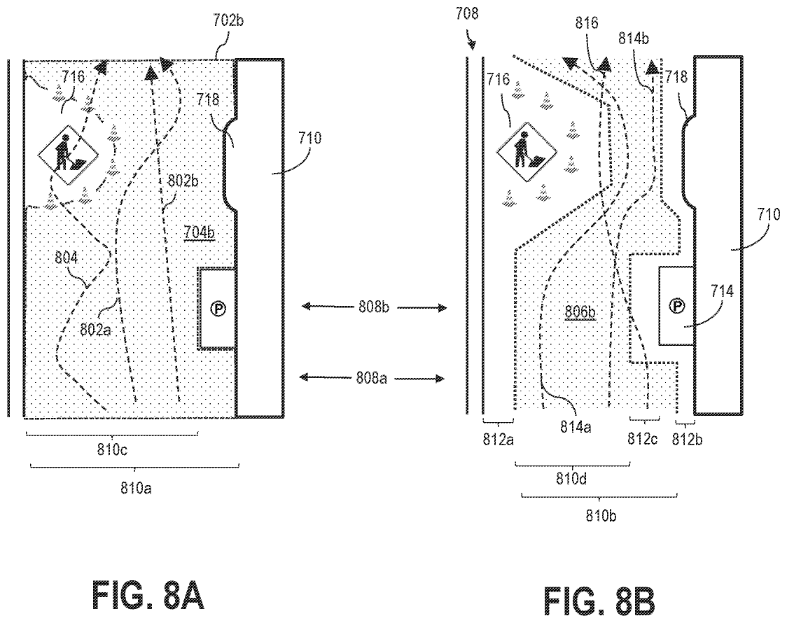

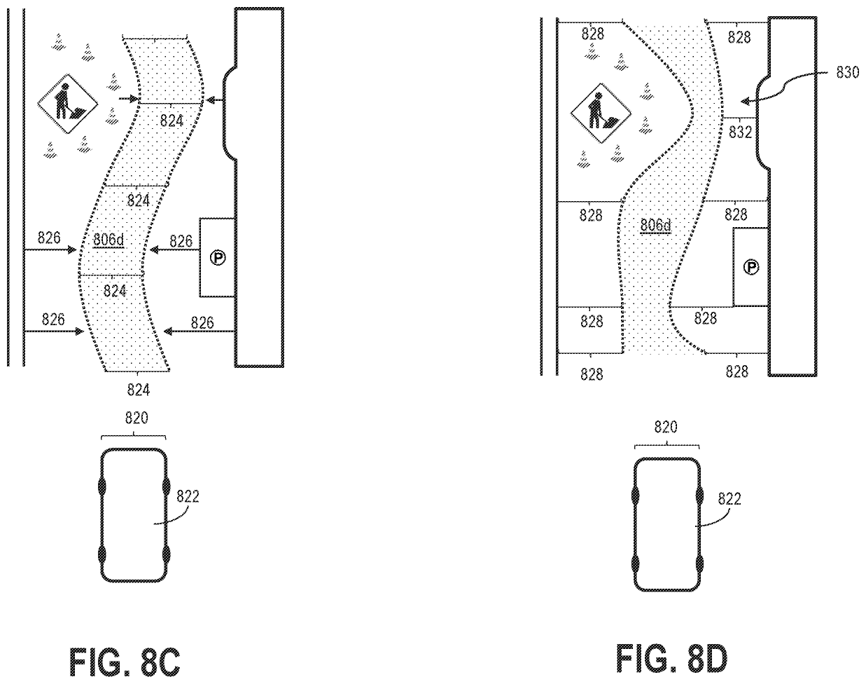

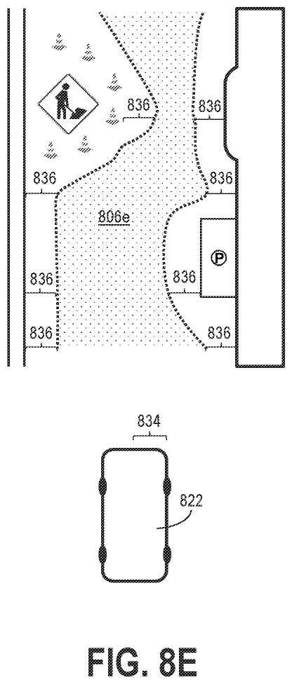

Determining a travel path through a road lane can include analyzing one or more candidate travel paths to determine a particular travel path that satisfies one or more criteria. Referring now to FIG. 8A, candidate travel paths 802a, 802b extend through road lane 704b. Travel path 804, besides extending through road lane 704b, further extends outside the road lane 704b, encroaching on the construction area 716. Accordingly, in some embodiments, travel path 802a would not be considered in a determination of a travel path; the determination can exclude, as candidates, any travel path that would go beyond certain bounds, such as the boundary 702b of the road lane 704b. Accordingly, the road lane 704b defines a search space for determination of the particular travel path. Two candidate travel paths 802a, 802b that do remain within the road lane 704b can be analyzed, e.g., by computing a cost associated with each candidate travel path 802a, 802b, as described in further detail below. For example, the candidate travel path with the lowest cost can be determined as the travel path. By contrast, a cost is not computed for travel path 804, because travel path 804 is outside the search space defined by the road lane 704b.

However, determination of the travel path based on the search space of the road lane 704b may be computationally burdensome and/or result in poor selection of the travel path. This is at least because there are candidate travel paths that are within the road lane 704b that would nevertheless be poor choices for a travel path, e.g., poor choices for a baseline travel path. For example, candidate travel path 802a, while not extending into the construction area 716, passes within a close proximity of the construction area 716. The close proximity may be closer than a width of a vehicle, such that, if the vehicle traveled along candidate travel path 802a, an edge of the vehicle would encroach on the construction area 716. Alternatively, even if the vehicle would not encroach on the construction area 716, it may be preferable for vehicles to stay further from certain types of environment features, e.g., for safety reasons. Accordingly, computation of a cost associated with the candidate travel path 802a (and/or other computational analysis of the candidate travel path 802a, depending on how travel paths are determined) represents wasted computation, extending the time consumed in determining a particular travel path and/or increasing the computational resources (e.g., processor and/or memory resources) consumed in performing the computation.

According to some embodiments of the present disclosure, referring again to FIG. 6, rather than directly using a first road lane indicated by mapping data (e.g., road lane 704b, referred to hereinafter as “first” road lane 704b) as a search space for travel path determination, a portion of the first road lane is identified as a “narrowed” road lane (604). The narrowed road lane has a reduced width in at least a portion of the narrowed road lane, compared to a corresponding width of the first road lane. Accordingly, the narrowed road lane represents a correspondingly-reduced search space, such that determination of the particular travel path can be made more computationally efficient.

Various methods and criteria can be used to identify the narrowed road lane. In some implementations, the narrowed road lane is defined at least in part based on one or more environmental features in proximity to the first road lane. For example, an area adjacent to at least one of the environmental features, included in the first road lane, can be excluded from the narrowed road lane. As shown in FIG. 88, a narrowed road lane 806b excludes areas adjacent to the road paint 708, the construction area 716, the parking spot 714, the curb 710, and the curb protrusion 718. For example, at a first roadway portion 808a, the first road lane 704b has width 810a, while the narrowed road lane 806b has width 810b, narrower by a first width 812a adjacent to the road paint 708 and a second width 812b adjacent to the curb 710. At a second roadway portion 808b, the first road lane 704b has width 810c, while the narrowed road lane 806b has width 810d, narrower by the first width 812a adjacent to the road paint 708 and a third width 812c adjacent to the parking spot 714.

The widths 812a, 812b, 812c (collectively referred to as widths 812) adjacent to environmental features, which define narrowed widths of the narrowed road lane 806b, can be the same as or different from one another, in various embodiments. In some embodiments, the widths 812 are determined at least based on a type of the environmental feature, where certain type(s) of environmental features can correspond to higher widths 812 than other types of environmental feature. For example, all else equal, in some embodiments, a curb feature or a parking spot may result in a wider adjacent area of the first road lane being excluded than a railing, because pedestrians may be more likely to be adjacent to the curb feature or the parking spot than the railing, such that it may be desirable for vehicles to remain further from the curb features or parking features than from rail/wall features.

In some embodiments, the widths 812 are determined based on one or more characteristics of the roadway of the road lane. For example, the widths 812 can be determined based on one or more of a curvature of the roadway (e.g., a curvature at the location where the width is defined), such as higher widths at locations of higher curvature, or a roadway type of the roadway, such as higher widths for urban streets and lower widths for urban freeways. Particular travel paths are to be determined using the narrowed road lane as a search space, such that the narrowed road lane can serve partially as a rough safety mechanism to shift vehicle movement towards safer road locations. In some embodiments, the widths 812 are instead or additionally determined based on a size of a vehicle (e.g., as described in reference to FIGS. 8C-8E) and/or based on geometry of the road lane or roadway, e.g., so as to be closer to a center of the road lane or roadway (e.g., as described in reference to FIG. 8C).

Referring to FIGS. 6 and 8B, a particular travel path is determined through the narrow road lane using a reduced search space based on the narrowed road lane (606). The narrowed road lane spatially restricts candidate travel paths (in some embodiments defined by nodes, as described in more detail below) that are evaluated (e.g., searched/tested) when performing one or more search processes, such as optimization processes, to determine the travel path from among multiple candidate travel paths. For narrowed road lane 806b, candidate travel paths 814a, 814b, which extend within the narrowed road lane 806b, are eligible for inclusion in the reduced search space, while travel path 816, which extends outside the narrowed road lane 806b, is ineligible for inclusion in the reduced search space, e.g., is not subject to analysis during determination of the travel path or is rejected as a possible travel path early in the determination process, receiving less consideration/analysis than candidate travel paths 814a, 814b.

Determination of the travel path from among the candidate travel paths of the reduced search space includes one or more suitable analysis processes to select the candidate travel path that best satisfies one or more criteria. The candidate travel paths can be analyzed in parallel and/or in sequence in an iterative process, e.g., using one or more pathfinding algorithms. The analysis process can include calculation of costs corresponding to the candidate travel paths. A non-limiting example of an algorithm is the A* algorithm. In the A* algorithm, a series of candidate travel paths are iteratively extended gradually from a starting point (e.g., a start of a road lane) to an ending point (e.g., an end of a road lane), attempting to minimize a cost of a cost function calculated based on the routes of the candidate travel paths. When a narrowed road lane is used as a reduced search space, the A* algorithm does not test candidate travel paths that extend outside the narrowed road lane.

The cost function can be based on one or more parameters of the candidate travel path. Non-limiting examples of such parameters include: distances of the candidate travel path from a center of the road lane (e.g., the narrowed road lane, the first road lane, or a roadway of the narrowed and first road lanes); curvatures of the candidate travel path (e.g., lower curvature might be associated with lower costs, to produce straighter travel paths that may be easier to navigate); distances of the candidate travel path from environmental feature(s) (e.g., higher distances from environmental features might be associated with lower costs, to produce travel paths that are further from obstacles); and total length of the candidate travel path (e.g., shorter total lengths might be associated with lower costs, for travel path navigation efficiency).

The reduction of the search space associated with use of the narrowed road lane, in some embodiments, acts as a pre-filtering of the candidate travel paths, such that the remaining candidate travel paths that are within the reduced search space are more likely to be close to the particular travel path, e.g., are more likely to have lower costs than travel paths excluded from the reduced search space. In some embodiments, this can speed up travel path determination. For example, when candidate travel paths are iteratively analyzed until the cost is below a threshold value, using an initial candidate travel path with a lower cost (based on the narrowed road lane generally being associated with lower costs) can reduce a number of iterations required for the cost to be below the threshold value. Moreover, because the search space itself is smaller, fewer iterations may be necessary to explore the search space, further reducing the computation time/cost associated with particular travel path determination.

In some embodiments, the narrowed road lane is identified based on a width of a vehicle. The vehicle can be, for example, a standard vehicle associated with a fleet of vehicles, e.g., a fleet of vehicles managed by a fleet management system 116. In some embodiments, different narrowed road lanes are identified for different vehicles having different sizes, and different particular travel paths for the different vehicles are determined based on the different narrowed road lanes.

As shown in FIG. 8C, a vehicle 822 has a vehicle width 820. From lateral boundaries of the first road lane 704b (as defined by environmental features in the environment), the first road lane 704b is shrunk (826) to obtain a narrowed road lane 806c having a lane width 824 (over at least a portion of the narrowed road lane 806c) that is based on the vehicle width 820. In some embodiments, the lane width 824 is at least the vehicle width 820. For example, the lane width 824 can be equal to the vehicle width 820 or larger by the vehicle width 820 by a predetermined factor or amount (e.g., the lane width 824 can be equal to 1.1 the vehicle width 820). In some cases, this may reduce computational instabilities associated with cost determination when the lane width 824 is less than the vehicle width 820. The lane width 824 can be obtained by shrinking the first road lane 704b from each lateral boundary equally over at least a portion of the narrowed road lane 806c, to obtain a narrowed road lane 806c that is centered equidistant from the lateral boundaries, and/or the width by which the first road lane 704b is shrunk can be unequal on each side over at least a portion of the narrowed road lane 806c, e.g., as described in reference to FIG. 8B. Accordingly, over at least a portion of the narrowed road lane 806c, the narrowed road lane 806c is identified based on the width 820 of the vehicle 822. Moreover, the narrowed road lane 806d is laterally centered relative to the first road lane 704b, which can be generally desirable for vehicle navigation.

FIG. 8D illustrates another example of identifying the narrowed road lane based on the vehicle width 820 of the vehicle 822. In this example, over at least a portion of a narrowed road lane 806d, the narrowed road lane 806d is spaced a spacing 828 from lateral boundaries of the first road lane 704b, where the spacing 828 is based on the vehicle width 820, e.g., as described for lane width 824. The width of the narrowed road lane 806d can be variable to accommodate the spacing 828 from boundaries (e.g., environmental features) on each side. In some embodiments, at location(s), such as location 830, where the spacing 828 would leave no room for the narrowed road lane 806d or otherwise cause the narrowed road lane 806d to have a width below a minimum width, the spacing (e.g., spacing 832) can be set to be smaller than the spacing 828 that is based on the width 820 of the vehicle 822. For portions of the narrowed road lane 806d that are spaced the spacing 828 from an environmental feature, where the spacing 828 (in some embodiments) is at least the width 820 of the vehicle 822, the vehicle 822 may avoid contact with the environmental feature as long as a portion of the vehicle remains within the narrowed road lane 806d, e.g., following a travel path within the narrowed road lane 806d. Accordingly, the narrowed road lane 806d provides a reasonable reduced search space based on which to determine a travel path.

FIG. 8E illustrates another example of identifying the narrowed road lane based on the vehicle width 820 of the vehicle 822. In this example, over at least a portion of a narrowed road lane 806e, the narrowed road lane 806e is spaced a spacing 836 from lateral boundaries of the first road lane 704b, where the spacing 836 is based on a width 834 that is half the vehicle width 820. In some embodiments, the spacing 836 is at least the width 834. For example, the spacing 836 can be equal to the width 834 or larger by the width 834 by a predetermined factor or amount. In some embodiments, at location(s) where the spacing 836 would leave no room for the narrowed road lane 806e or otherwise cause the narrowed road lane 806e to have a width below a minimum width, the spacing can be set to be smaller than the spacing 836. For portions of the narrowed road lane 806e that are spaced the spacing 836 from an environmental feature, where the spacing 836 (in some embodiments) is at least the width 834 that is half the vehicle width 820 of the vehicle 822, the vehicle 822 may avoid contact with the environmental feature as long as the lateral middle of the vehicle remains within the narrowed road lane 806e, e.g., following a travel path within the narrowed road lane 806e. Accordingly, the narrowed road lane 806e provides a reasonable reduced search space based on which to determine a travel path, because, in some embodiments, the travel path will be navigated by the vehicle 822 with the lateral middle of the vehicle 822 along the travel path.

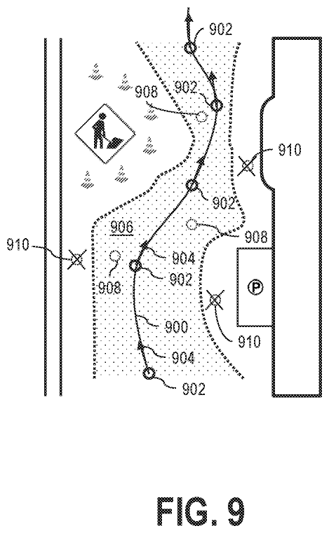

In some embodiments, the particular travel path is defined by nodes. Determining the particular travel path (e.g., in element 606) can include determining the nodes, e.g., by analyzing sets of candidate nodes that, in some embodiments, define candidate travel paths. FIG. 9 illustrates a particular travel path 900 defined by multiple nodes 902. In different embodiments, the nodes 902 can be of one or more types that have various characteristics. In the example of FIG. 9, the nodes 902 are Dubins nodes that are each associated with a position (e.g., a longitude and latitude) and a heading (e.g., headings 904), the heading defining the direction of the travel path 900 at the node 902. Other type(s) of nodes are also within the scope of this disclosure for use in determining travel paths. For example, in some embodiments, a travel path is a Bezier curve defined by multiple nodes, e.g., combinations of end points and control points. In some embodiments, a travel path is defined by multiple nodes associated with headings, where the headings have headings in both horizontal and vertical directions (e.g., increased dimensionality compared to some Dubins nodes in which headings are confined to a single plane).

To determine a node-based travel path, candidate nodes can be moved, added, removed, and/or altered (e.g., have their headings altered) in an iterative process to arrive at a set of nodes that satisfies one or more criteria, or that defines a travel path satisfying one or more criteria. For example, a candidate set of nodes can define a candidate travel path through a road lane. If the candidate travel path satisfies one or more criteria (e.g., has a cost, based on a cost function such as a cost function as described above, that is less than a threshold value), the candidate travel path is determined as the travel path. If the candidate travel path does not satisfy the one or more criteria, at least one node is moved, added, removed, or altered to define another candidate travel path. This process can continue in an iterative fashion to determine the travel path. In some embodiments, the iterative process searches for a particular travel path having a cost that is a local or global minimum cost, compared to other candidate travel paths; that particular travel path is determined to satisfy the one or more criteria.

In some embodiments, when a node-based travel path is determined using a reduced search space of a narrowed road lane, the iterative process does not include analysis of travel paths that are defined by nodes outside the narrowed road lane. For example, the locations of candidate notes during travel path determination are limited to the narrowed road lane. Referring to FIG. 9, nodes 908 have locations within a narrowed road lane 906 and may, in some cases, be candidate Dubins nodes that define a candidate travel path during determination of the particular travel path 900. By contrast, nodes 910 have locations outside the narrowed road lane 906 and accordingly are ineligible to define a candidate travel path during determination of the determination of the particular travel path 900.

In some embodiments, an initial set of nodes is defined to begin the iterative process, and the initial set of nodes is restricted to locations within the narrowed road lane 906. In some embodiments, as an iterative process continues, when locations of one or more candidate nodes are adjusted, and/or when one or more additional candidate nodes is added, the adjusted locations and/or the locations of the one or more additional candidate nodes are restricted to locations within the narrowed road lane 906. Accordingly, the narrowed road lane 906 represents a reduced search space that can reduce a number of iterations to be performed in determining the particular travel path 900, and/or otherwise ease the computational burden of determining the particular travel path 900.

In some embodiments, nodes that define a travel path are determined using a shrinking hypercube optimization process. The shrinking hypercube optimization process can be used in conjunction with a reduced search space associated with a narrowed road lane, or can be utilized on an “un-narrowed” road lane, e.g., the first road lane 704b.

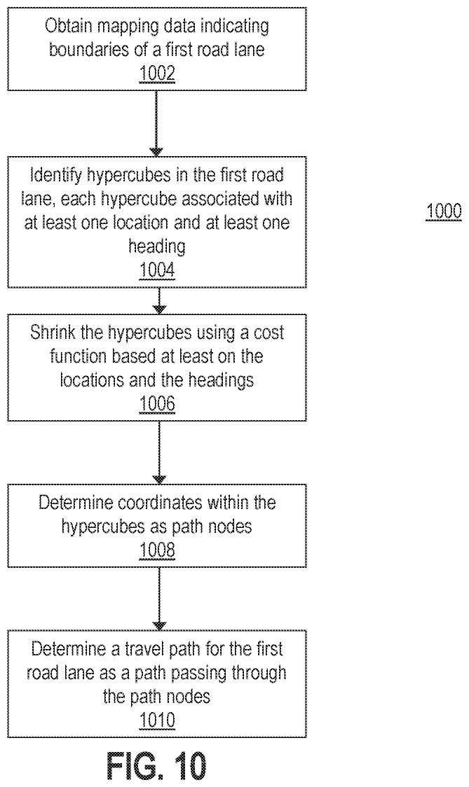

As shown in FIG. 10, in an example of a process 1000 including shrinking hypercube optimization, mapping data is obtained, the mapping data indicating boundaries of a first road lane (1002). For example, element 1002 can be performed as described for element 602 above. Process 1000 can be performed by a system of an autonomous or semi-autonomous vehicle (e.g., by autonomous vehicle compute 400), by one or more systems remote to a vehicle (e.g., fleet management system 116 and/or vehicle-to-infrastructure system 118), or a combination thereof.

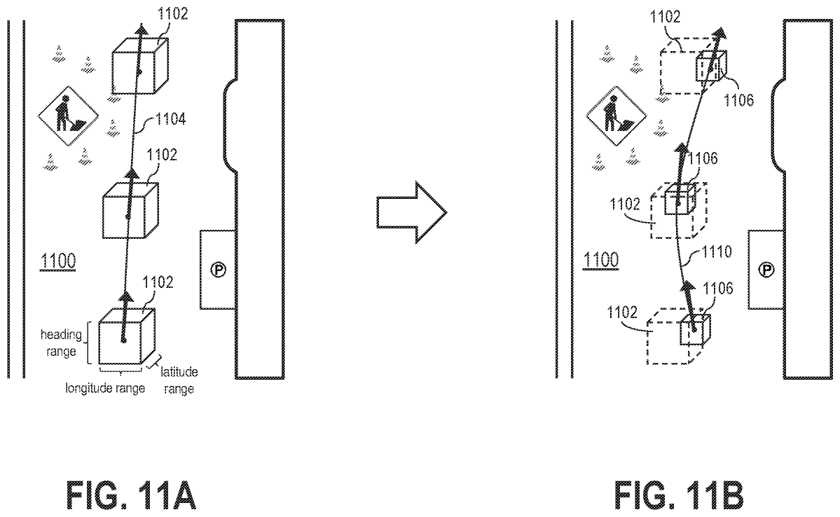

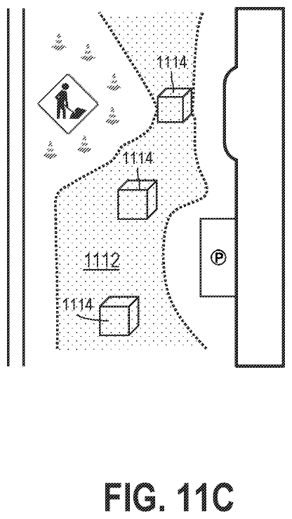

A set of hypercubes is identified (e.g., initialized) in the first road lane (1004). “Hypercubes,” as used herein, includes hypercuboids, e.g., where the dimensions of the hypercuboids in each dimension need not be equal. In some embodiments, each hypercube is associated with a range of locations and a range of headings. FIG. 11 illustrates an example of hypercubes 1102 identified in a first road lane 1100. In this example, each hypercube 1102 is a three-dimensional hypercube (a cube) associated with a longitude range, a latitude range, and a heading range, the three ranges defining respective dimensions of the hypercube 1102. The longitude range and the latitude range each represent a range of positions for a node (e.g., a Dubins node) corresponding to the hypercube 1102. “Longitude” and “latitude” are non-limiting examples of positional coordinates that can have ranges defined by the hypercubes; in some implementations, each hypercube is associated with a range of x-coordinates and a range of y-coordinates in a global or local reference frame, or another pair of ranges of coordinates that together define a range of positions of a node associated with the hypercube. The heading range represents a range of headings for the node corresponding to the hypercube 1102. Accordingly, a set of nodes (e.g., Dubins nodes), each node located within a respective hypercube, defines a corresponding candidate travel path.

For example, a given identified hypercube 1102 has center position (x₀, y₀, h₀), where x₀ is a longitude, y₀ is a latitude, and h₀ is a heading (e.g., an angle based on cardinal directions, such as 0° for true north and 90° for true east). The hypercube 1102 also has side lengths Δₓ, Δ_{y}, Δₕ defining a range of longitudes x₀−Δx/2<x<x₀+Δx/2, a range of latitudes y₀−Δy/2<y<y₀+Δy/2, and a range of headings h₀−Δh/2<h<h₀+Δh/2. A given coordinate (x, y, h) within the hypercube defines a Dubins node, and a set of {x, y, h} for the set of hypercubes 1102 in the first road lane 1100 defines a candidate travel path defined by the Dubins nodes. As shown in FIG. 11A, candidate travel path 1104 is defined by the centers {x₀, y₀, h₀} of each hypercube 1102.

The hypercubes 1102 can be initialized in various ways in different embodiments. In some embodiments, the hypercubes 1102 are initialized with locations approximately in lateral centers (e.g., within 10% or within 20% of lateral centers) of the road lane 906. The initialization can be partially random, e.g., hypercube locations randomly distributed in a specified range. In some implementations, the partially random initialization conforms to a distribution, such as locations distributed in a Gaussian distribution or a uniform distribution around lateral centers of the road lane 906. In some embodiments, the hypercubes 1102 are initialized with equal spacings or approximately equal spacings between one another. In some embodiments, a point-reduction algorithm such as the Douglas-Peucker algorithm or the Visvalingam-Whyatt algorithm is applied to a set of points in the road lane, such as a set of lateral center points in the road lane 906; for each point remaining after point-reduction, a hypercube is initialized centered (in longitude and latitude) at the point or in proximity to the point, e.g., having a random lateral location as described above.

In a shrinking hypercube optimization process as described herein, the hypercubes are iteratively shrunk using a cost function based on at least the locations and the headings associated with each hypercube (1006). In some embodiments, the shrinking hypercubes are shrunk on a search space using a cost function computed on two or more dimensions per points/nodes in the search space. N coordinates (e.g., uniformly-distributed or randomly-distributed coordinates) within each hypercube are selected, where N>1, and the N coordinates from each hypercube are distributed into N sets of coordinates, where each set of coordinates includes a coordinate from each hypercube. The N sets of coordinates define N candidate travel paths. Respective costs (based on a cost function as described above) are determined for each of the N candidate travel paths. Based on the respective costs, a displacement-shrink process is performed in which at least one of the hypercubes 1102 is shrunk in at least one dimension (e.g., at least one of Δₓ, Δ_{y}, and Δₕ decreases for at least one hypercube 1102), and at least one of the hypercubes is displaced (has its center (x₀, y₀, h₀) shifted), to obtain new hypercubes 1106 (1006). For example, in some embodiments, a center of each new, iterated hypercube 1106 is the average between the previous center of the corresponding hypercube 1102 and the coordinate within the hypercube that defined the candidate travel path having the lowest cost among the N calculated costs. In some embodiments, an amount of shrinking of each hypercube 1106 compared to the corresponding hypercube 1102 is based on an amount of displacement of the center of the hypercube 1106 compared to the hypercube 1102: the amount of shrinking can be greater for lower displacements, corresponding to higher confidence that the hypercube is being iterated towards an optimal value. Other displacement and/or shrinking processes are also within the scope of this disclosure.

In some embodiments, the shrinking hypercube optimization process includes a “searching space process” in which a new set of hypercubes is initialized and iterated. For example, the searching space process can be performed if the costs of analyzed candidate travel paths fail to converge (e.g., after a predetermined number of displacement-shrink iterations) and/or if the costs of analyzed candidate travel paths fail to satisfy a threshold condition (e.g., after a predetermined number of displacement-shrink iterations).

The displacement-shrink process can continue (in some embodiments, with one or more searching space processes) until one or more stopping conditions are met. For example, in some implementations, the displacement-shrink process continues until (i) a candidate travel path 1110 defined by coordinates within the hypercubes 1106 (e.g., defined by the centers of the hypercubes 1106) has a cost less than a threshold cost, and (ii) other candidate travel paths defined by the coordinates within the hypercubes 1106 have higher costs than the candidate travel path 1110; this combination of conditions can represent convergence of the shrinking hypercube optimization process. The candidate travel path 1110 (in this example, the candidate travel path passing through and defined by Dubins nodes defined by centers of the hypercubes 1106) is determined as the particular travel path for the road lane 1100. Other and/or additional stopping conditions for terminating a shrinking hypercube optimization process and determining a resulting particular travel path are also within the scope of this disclosure.

Shrinking hypercube optimization, as used for determination of nodes to determine travel paths, can, in some embodiments, be particularly-well suited for the specific task of travel path determination. This may provide faster and/or less computationally-demanding results than other processes used to determine travel paths. Moreover, in some embodiments, the travel paths determined by shrinking hypercube optimization are more optimal (e.g., have lower calculated costs) than travel paths determined by other processes.

In some implementations, some computational aspects of the shrinking hypercube optimization process can be performed as described in “Optimization of High-Dimensional Functions through Hypercube Evaluation,” Abiyev & Tunay (2015) (incorporated herein by reference in its entirety), which describes generic single-hypercube optimization without reference to travel paths or nodes.

As noted above, shrinking hypercube optimization to determine nodes of travel lanes need not be, but can be, applied to narrowed road lanes that provide reduced search spaces. In reference to FIG. 11C, a narrowed road lane 1112 (compared to the first road lane 1100) is identified, e.g., as described in reference to FIGS. 8A-8E. A set of hypercubes 1114 is initialized, the hypercubes 1114 spatially limited to the narrowed road lane 1112 (e.g., to have spatial centers (x₀, y₀) within the narrowed road lane and/or or to have spatial bounds that do not extend outside the narrowed road lane). The hypercubes 1114 can have characteristics as described for the hypercubes 1102/1106, e.g., each defining ranges of longitudes, latitudes, and headings. The hypercubes 1114 are iteratively shrunk/displaced as described in reference to FIGS. 11A-11B. In the displacement-shrink process, the subsequent iterations of the hypercubes 1114 are also spatially limited to the narrowed road lane 1112. After one or more iterations, a travel path based on the iterated hypercubes is determined, e.g., a travel path defined by coordinates within the hypercubes. Because the narrowed road lane 1112 (i) limits/guides the locations of the initialized hypercubes 1114 and (ii) limits the spatial search space, in some embodiments, the particular travel path can be more desirable (e.g., have a lower calculated cost) and/or use fewer iterations, or otherwise consume fewer computing resources, than a comparable travel path determined based on a first, un-narrowed road lane.

As shown in Table 1 below, computational experiments were conducted using shrinking hypercube optimization with and without narrowed lanes. The compute time consumed in determining particular travel paths was reduced by 82% using narrowed lanes compared to using un-narrowed lanes. In addition, the distance error associated with the determined particular travel paths, compared to expert-determined particular travel paths based on best navigation practices, was reduced by 60% for in-lane travel paths and by 6% for connector paths (described in more detail below). Moreover, the error rate in determining lane connections (generating lane connections that experts did not generate) was reduced by 38%. That is, the use of a reduced search space can both make particular travel path determination more computationally efficient and improve the quality of the particular travel paths, a “win-win” result.

TABLE 1

| | Performance | | | |
|---|---|---|---|---|
| | | 90th percentile distance | | Computa- |
| | | error (meters) | | tion cost |
| | | | Lane | per path |
| Experiment | Error rate | Lane | connector | (seconds) |
| Shrinking hypercube | 8.6% | 0.401 | 1.166 | 1.864 |
| path determination | | | | |
| Shrinking hypercube | 5.4% | 0.16 | 1.089 | 0.334 |
| path determination | (38% | (60% | (6% | (82% |
| with narrowed lanes | reduction) | reduction) | reduction) | reduction) |

In some embodiments, node-based path determination is extended to determine “connector paths” between two road lanes. For example, the two road lanes can be joined by an intersection or a third road lane, and a travel path (e.g., a baseline travel path) can be determined for vehicle navigation through the intersection or third road lane from one road lane to another.

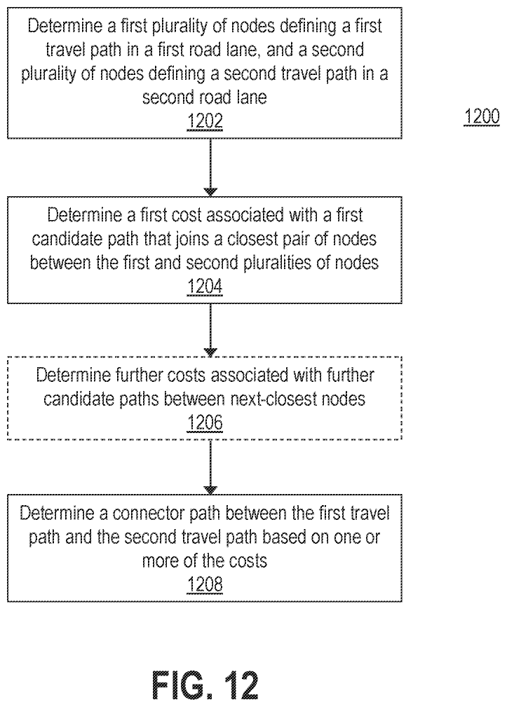

As shown in FIG. 12, in an example of a process 1200, a first plurality of nodes and a second plurality of nodes are determined (1202). The first plurality of nodes define a first travel path in a first road lane, and the second plurality of nodes define a second travel path in a second road lane. Process 1200 can be performed by a system of an autonomous or semi-autonomous vehicle (e.g., by autonomous vehicle compute 400), by one or more systems remote to a vehicle (e.g., fleet management system 116 and/or vehicle-to-infrastructure system 118), or a combination thereof.

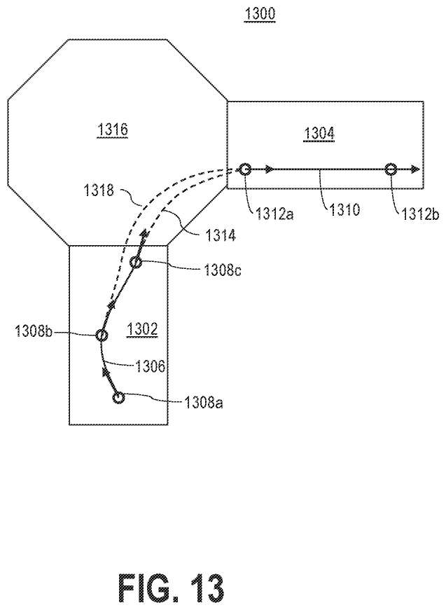

In reference to FIG. 13, an environment 1300 includes a first road lane 1302 and a second road lane 1304. A first travel path 1306, defined by nodes 1308a, 1308b, 1308c (e.g., Dubins nodes) is defined through the first road lane 1302, and a second travel path 1310, defined by nodes 1312a, 13212b, is defined through the second road lane 1304. An intersection 1316 joins the road lanes 1302, 1304. The travel paths 1306, 1310 can be determined as described throughout this disclosure, e.g., in reference to FIGS. 6, 8A-8E, 9, 10, and 11A-11C, such as with use of narrowed road lanes and/or with use of shrinking hypercube optimization.

The process 1200 includes determining a first cost associated with a first candidate travel path that joins a closest pair of nodes between the first and second pluralities of nodes (1204). For example, candidate travel path 1314 joins the closest pair of nodes 1308c and 1312a between the two travel paths 1306, 1310. The candidate travel path 1314 is defined by the two nodes 1308c, 1312a, e.g., by respective locations and headings of the nodes 1308c, 1312a in a Dubins node formulation that maintains an unbroken, continuous sequence of travel paths 1306, 1314, 1310. The cost of the candidate travel path 1314 can be determined using a cost function as described above, e.g., a cost function based on one or more of: curvatures of the candidate travel path 1314; distances of the candidate travel path 1314 from environmental feature(s), such as environmental features that define boundaries of the intersection 1316; total length of the candidate travel path 1314; or whether the candidate travel path 1314 extends outside a boundary of the intersection 1316 (which, in some embodiments, has an effectively infinite cost that renders the candidate travel path 1314 impermissible.

In some embodiments, the determined cost is compared to a threshold condition. If the determined cost satisfies the threshold condition (e.g., has a value below a threshold value), then the candidate travel path 1314 is selected as the connector path through the intersection 1316 (1208), e.g., as a baseline travel path along which vehicles will navigate in the absence of sensor data that prevents the navigation. However, if the cost does not satisfy the threshold condition, further candidate travel paths can be analyzed until a candidate travel path that satisfies the threshold condition is identified. Alternatively, in some embodiments, after a cost is determined for the first candidate travel path 1314, one or more other candidate travel paths are analyzed, and the candidate travel path having the lowest cost is selected as the connector path, e.g., without reference to satisfying a threshold condition.

In some embodiments, costs are determined for one or more other candidate travel paths between next-closest nodes (1206). For example, after analysis of candidate travel path 1314 between nodes 1308c and 1312a, a cost can be determined for candidate travel path 1318 between nodes 1308b and 1312a. Alternatively, or in addition, a cost can be determined for a candidate travel path between nodes 1308c and 1312b (not illustrated). In some cases, these candidate travel paths can be understood as representing earlier preparation for a turn. For example, rather than waiting until very close to the intersection 1316 to prepare for a turn (at node 1308c), a human driver may alter their navigation in preparation for the turn earlier, e.g., at node 1308b. “Tracing back” the nodes that define the candidate travel paths (through further-back nodes of either or both of the first travel path 1306 and the second travel path 1310) can represent this behavior computationally in a relatively simple manner.

In some embodiments, when a candidate travel path having a cost that satisfies a threshold condition is determined, that candidate travel path is determined as the connector path. In some embodiments, a predetermined number of candidate travel paths are analyzed, and the candidate travel path having the lowest cost is determined as the connector path. For example, candidate travel paths can be “traced back” by two, to analyze candidate travel paths 1314, 1318, a candidate travel path between node 1308c and node 1312b, and a candidate travel path between node 1308b and node 1312b. The candidate travel path, of these four, having the lowest cost is determined as the connector path through the intersection 1316.

The determined connector path can at least partially determine navigation through between the two road lanes, e.g., between road lanes 1302 and 1304 through the intersection 1316. When an autonomous or semi-autonomous vehicle is to navigate from the first road lane 1302 to the second road lane 1304, the autonomous or semi-autonomous vehicle can follow the connector path as a baseline travel path.

In some implementations, connector paths are determined based on a reduced search space resulting from narrowed roadways, as described above. The narrowed roadways can be narrowed versions of the road lanes 1302, 1304 as described above (e.g., narrowed versions based on which nodes 1308, 1312 were determined as described above) and/or narrowed intersections 1316. The intersection 1316 can be narrowed as described above, by bringing boundaries of the intersection 1316 closer to one another based on environmental features (e.g., construction areas) and/or based on a width of the vehicle. Narrowed roadways for connector path determination affect the costs associated with connector paths, for example, by altering a distance between a given connector path and a boundary of the (narrowed or un-narrowed) road lane or intersection. In some cases, costs associated with narrowed roadways can be more useful than costs associated with un-narrowed roadways, e.g., can indicate connector paths that are more similar to expert-determined connector paths.

The particular travel path(s) for a given environment, once determined, can be used to guide navigation of one or more vehicles. In some embodiments, the particular travel paths are determined by one or more computing systems remote from a vehicle, and the particular travel paths are provided to the vehicle for use by the vehicle. For example, fleet management system 116 can receive mapping data for a given environment (e.g., a city), determine particular travel paths (in some embodiments, including connector paths) for road lanes in the environment, and provide the particular travel paths to one or more vehicles 102. The vehicle 102 can store the particular travel paths, such as in planning system 404 or database 410. The vehicle 102 (e.g., planning system 404) can determine routes to navigate based on the store particular travel paths. For example, the particular travel paths can define baseline travel paths along which the vehicle 102 “ideally” navigates, in the absence of sensor or other data indicating that the vehicle 102 should deviate from the baseline travel path, e.g., due to obstacles, lane closures, etc.

In some embodiments, the particular travel paths are determined by a vehicle, e.g., by planning system 404 of a vehicle 102. Based on the high computational efficiency of one or more of the processes described herein (such as narrowed lane-based path determination and/or node-based path determination with shrinking hypercube optimization), particular travel paths for a given road lane can be determined very quickly, e.g., in real-time or near-real-time. Accordingly, in some embodiments, an autonomous vehicle compute 400 determines travel paths based on sensor data provided by the perception system 402. For example, sensor data can indicate the presence of an environmental feature in a vicinity of a road lane, e.g., a transient environmental feature of which remote systems, such as fleet management system 116, are unaware. The autonomous vehicle compute 400 can identify a narrowed road lane based at least one the environmental feature, e.g., by excluding an area adjacent to the environmental feature, and determine a particular travel path based on the narrowed road lane. The autonomous vehicle compute 400 can then cause the vehicle 102 to navigate the road lane using the particular travel path, e.g., using the particular travel path as a baseline travel path. Accordingly, navigation can be improved using sensor data obtained in real-time shortly before vehicles navigate road lanes.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method comprising:
obtaining, by at least one processor, mapping data characterizing an environment, the mapping data indicating boundaries of a first road lane in the environment;
identifying, by the at least one processor, a portion of the first road lane as a narrowed road lane, the narrowed road lane having a reduced width in at least a portion of the narrowed road lane compared to a width of the first road lane;
evaluating, by the at least one processor, a plurality of candidate travel paths in a search space that includes the narrowed road lane and excludes at least a portion of the first road lane that is not included in the narrowed road lane; and
determining, by the at least one processor, a particular travel path for a vehicle through the narrowed road lane based on the evaluation of the plurality of candidate travel paths, wherein the plurality of candidate travel paths include the particular travel path.

2. The method of claim 1, further comprising:
identifying, by the at least one processor, the narrowed road lane using an environmental feature in proximity to the first road lane.

3. The method of claim 2, wherein identifying the narrowed road lane comprises identifying the narrowed road lane based on a parking feature, a curb feature, or a construction feature.

4. The method of claim 1, wherein identifying the portion of the first road lane as the narrowed road lane comprises:
excluding, from the narrowed road lane compared to the first road lane, an area adjacent to the environmental feature.

5. The method of claim 1, further comprising:
identifying, by the at least one processor, the narrowed road lane using a width of the vehicle.

6. The method of claim 1, further comprising:
identifying, by the at least one processor, the narrowed road lane based on a center of the first road lane.

7. The method of claim 1, wherein determining the particular travel path for the vehicle through the narrowed road lane comprises applying an optimization process to determine the particular travel path, the method further comprising:
applying, by the at least one processor, the optimization process to determine a plurality of nodes in the narrowed road lane,
wherein the particular travel path is based at least on the plurality of nodes.

8. The method of claim 7, wherein applying the optimization process comprises applying a shrinking hypercube optimization process.

9. The method of claim 8, wherein applying the shrinking hypercube optimization process comprises identifying a plurality of hypercubes that are each associated with a location in the environment and a heading in the environment.

10. The method of claim 9, wherein determining the plurality of nodes comprises determining the plurality of nodes as centers of the plurality of hypercubes.

11. The method of claim 7, wherein the particular travel path is a first travel path, wherein the plurality of nodes is a first plurality of nodes, and wherein the method comprises:
determining, by the at least one processor, a connector path that joins the first travel path through the narrowed road lane to a second travel path through a second road lane, the second travel path determined based at least on a second plurality of nodes,
wherein determining the connector path comprises:
determining a cost associated with a first candidate travel path that joins a first node in the first plurality of nodes to a second node in the second plurality of nodes,
wherein the first node and the second node are a closest pair of nodes between the first plurality of nodes and the second plurality of nodes.

12. The method of claim 11, wherein the mapping data indicates boundaries of a first intersection between the first road lane and the second road lane, and wherein determining the connector path comprises:
identifying a portion of the first intersection as a narrowed intersection, the narrowed intersection having a reduced area compared to the first intersection; and
determining the first candidate path as a path through the narrowed intersection.

13. The method of claim 11, wherein determining the connector path comprises:
determining that the cost satisfies a threshold condition; and
based at least on determining that the cost satisfies the threshold condition, determining that the connector path includes the first candidate travel path.

14. The method of claim 11, wherein determining the connector path comprises:
determining that the cost does not satisfy a threshold condition; and
based at least on determining that the cost does not satisfy the threshold condition, determining a second cost associated with a second candidate travel path that joins the first node to a third node in the second plurality of nodes,
wherein a distance between the first node and the second node is less than a distance between the first node and the third node.

15. The method of claim 1, comprising providing, by the at least one processor, the path to a vehicle for use in navigation of the first road lane.

16. A system, comprising:
at least one processor; and
at least one memory storing instructions thereon that, when executed by the at least one processor, cause the at least one processor to:
obtain mapping data characterizing an environment, the mapping data indicating boundaries of a first road lane in the environment;
identify a portion of the first road lane as a narrowed road lane, the narrowed road lane having a reduced width in at least a portion of the narrowed road lane compared to a width of the first road lane;
evaluating, by the at least one processor, a plurality of candidate travel paths in a search space that includes the narrowed road lane and excludes at least a portion of the first road lane that is not included in the narrowed road lane; and
determining, by the at least one processor, a particular travel path for a vehicle through the narrowed road lane based on the evaluation of the plurality of candidate travel paths, wherein the plurality of candidate travel paths include the particular travel path.

17. The system of claim 16, wherein the instructions further cause the at least one processor to identify the narrowed road lane using an environmental feature in proximity to the first road lane.

18. The system of claim 16, wherein determining the particular travel path for the vehicle through the narrowed road lane comprises applying an optimization process to determine the particular travel path, and wherein the instructions further cause the at least one processor to:
apply the optimization process to determine a plurality of nodes in the narrowed road lane,
wherein the particular travel path is based at least on the plurality of nodes.

19. A non-transitory computer readable medium comprising instructions stored thereon that, when executed by at least one processor, cause the at least one processor to carry out operations comprising:
obtaining mapping data characterizing an environment, the mapping data indicating boundaries of a first road lane in the environment;
identifying a portion of the first road lane as a narrowed road lane, the narrowed road lane having a reduced width in at least a portion of the narrowed road lane compared to a width of the first road lane;
evaluating, by the at least one processor, a plurality of candidate travel paths in a search space that includes the narrowed road lane and excludes at least a portion of the first road lane that is not included in the narrowed road lane; and
determining, by the at least one processor, a particular travel path for a vehicle through the narrowed road lane based on the evaluation of the plurality of candidate travel paths, wherein the plurality of candidate travel paths include the particular travel path.

20. The non-transitory computer readable medium of claim 19, wherein the operations further comprise identifying the narrowed road lane using an environmental feature in proximity to the first road lane

21. A method comprising:
obtaining, by at least one processor, mapping data characterizing an environment, the mapping data indicating boundaries of a first road lane in the environment;
identifying, by the at least one processor, a plurality of hypercubes in the first road lane, wherein each of one or more hypercubes of the plurality of hypercubes is associated with at least one location in the environment and at least one heading in the environment;
shrinking, by the at least one processor, the plurality of hypercubes using a cost function based at least on the locations and the headings of the one or more hypercubes;
in response to a value of the cost function satisfying a threshold condition, determining, by the at least one processor, a coordinate within each of the one or more hypercubes as a path node; and
determining, by the at least one processor, a travel path for the first road lane as a path passing through the one or more path nodes defined as coordinates within the one or more hypercubes.
